(19) United States
(12) Patent Application Publication
(10) Pub. No.: US 2026/0184123 A1
(43) Pub. Date: Jul. 2, 2026

(54) SHOCK-ABSORBING TRAILER HITCH

(71) Applicant: Qingdao Kemei Trailer CO.,LTD, QINGDAO (CN)

(72) Inventors: GUOHAO GONG, Qingdao (CN); HAOJUN GONG, Qingdao (CN); DESHENG GONG, Qingdao (CN)

(21) Appl. No.: 19/548,989

(22) Filed: Feb. 25, 2026

(51) Int. Cl. B60D 1/24; B60D 1/58

(52) U.S. Cl. CPC B60D 1/249; B60D 1/58

(57) ABSTRACT

The present disclosure provides a shock-absorbing trailer hitch, including a shock-absorbing trailer hitch, a buffer sleeve, locking pins, and a shock-absorbing trailer hitch receiver tube; where a trailer hitch beam of the shock-absorbing trailer hitch is connected to a vehicle on both sides and connected to a hexagonal rod of the shock-absorbing trailer hitch receiver tube in the middle through the buffer sleeve, and the locking pin connects the three in a locked manner. The shock-absorbing trailer hitch is connected to the trailer hitch beam and a first trailer hitch receiver tube through a shock-absorbing spring, and the shock-absorbing trailer hitch receiver tube is connected to the hexagonal rod and a second trailer hitch receiver tube through a shock-absorbing spring, thereby forming a dual shock-absorbing mechanism. The buffer sleeve cooperates with a triple locking structure and a dual-position spare design to achieve a secure connection and shock-absorbing anti-movement.

### TECHNICAL FIELD

The present disclosure belongs to the technical field of automotive trailer hitches, and more particularly relates to a shock-absorbing trailer hitch.

### BACKGROUND

In the field of automotive towing and hauling, a secure connection between a towing vehicle and a trailer is crucial for ensuring driving safety and effective transmission of a towing force. As a key connecting assembly, the structural rationality of the trailer hitch directly determines the performance and application scope of an entire towing system. Currently, mainstream trailer hitches in the industry mostly employ rigid connection structures. Such structures exhibit several prominent drawbacks in practical application: The flexibility during travel is poor, and the structures are especially prone to interference during turning, thereby affecting handling precision; on a bumpy road, the rigid connection cannot absorb shock energy, which not only risks prying damage but also generates intense vibration noise, reducing driving comfort; and moreover, the unitary structural design lacks adaptability, making it difficult to meet market demands for product diversity and multi-functionality. Additionally, insufficient designs of conventional trailer hitches in terms of connection reliability, safety protection performance, and component installation convenience further limit their application in complex road conditions and diverse usage scenarios. Therefore, there is an urgent need for structural optimization and improvement of the trailer hitch to overcome the numerous drawbacks of the prior art.

### SUMMARY

To solve the above technical problems, the present disclosure provides a shock-absorbing trailer hitch, which solves the technical problems of a conventional rigid-connection trailer hitch such as poor flexibility during travel, easy interference during turning, susceptibility to damage and vibration noise generated under bumpy road conditions, as well as insufficient adaptability and safety.

A shock-absorbing trailer hitch includes a shock-absorbing trailer hitch, a buffer sleeve, locking pins, and a shock-absorbing trailer hitch receiver tube;

a trailer hitch beam of the shock-absorbing trailer hitch is connected to a vehicle on both sides and connected to the buffer sleeve in the middle; the buffer sleeve is connected to a hexagonal rod of the shock-absorbing trailer hitch receiver tube; and the locking pin is configured to connect the shock-absorbing trailer hitch, the buffer sleeve, and the shock-absorbing trailer hitch receiver tube in a locked manner; and

the shock-absorbing trailer hitch is formed by connecting the trailer hitch beam and a first trailer hitch receiver tube through a shock-absorbing spring, the trailer hitch beam and the first trailer hitch receiver tube are fixedly connected by a high-strength bolt and a lock nut, and reinforcing plates are disposed on both sides of the first trailer hitch receiver tube.

Preferably, the shock-absorbing trailer hitch receiver tube is formed by connecting the hexagonal rod and a second trailer hitch receiver tube through a shock-absorbing spring, and the hexagonal rod and the first trailer hitch receiver tube are in a clearance fit and are in a non-circular fit.

Preferably, the buffer sleeve is made of a wear-resistant buffering material, and configured to connect the hexagonal rod and the first trailer hitch receiver tube, and a clearance is retained between the buffer sleeve and the first trailer hitch receiver tube.

Preferably, a pin stem of the locking pin is screwed into a locking cavity through a latch slot, double holes are formed at an end portion of the pin stem, the double holes are connected to a clip and a coded lock, respectively, and the locking pin is further provided with a pin handle.

Preferably, the shock-absorbing trailer hitch is provided with a bent beam structure and dual-chain fixing plates, the bent beam is configured to enhance vehicle passive safety and provide a mounting base, and the dual-chain fixing plates serve a dual safety protection function.

Preferably, locking pins employ a dual-position same-model design, and one locking pin serves as a spare; when a trailer is not connected, the inner locking pin fixes the first trailer hitch receiver tube and the trailer hitch beam; and the shock-absorbing trailer hitch is configured with a detachable hitch step, the detachable hitch step is placed flat on a top surface of the first trailer hitch receiver tube and is fixed at four positions by the locking pin and auxiliary side plates, and the detachable hitch step is fixed for use on either the first trailer hitch receiver tube or the second trailer hitch receiver tube.

Preferably, the shock-absorbing spring is any one of a helical spring, a polyurethane spring, a hydraulic spring, a nitrogen spring, an airbag spring, a leaf spring, a torsion bar spring, and a rubber spring; and the shock-absorbing spring mechanisms of the shock-absorbing trailer hitch and the shock-absorbing trailer hitch receiver tube employ a dual-position reinforcement design.

Compared with the prior art, the present disclosure has the following beneficial effects:

Through the dual shock-absorbing spring structures of the shock-absorbing trailer hitch and the shock-absorbing trailer hitch receiver tube, in combination with the elastic buffering effect of the buffer sleeve, shock forces generated by vehicle starting, braking, bumping, and gear shifting can be efficiently absorbed, thereby significantly reducing continuous vibrations and peak stress, and preventing the shaking drawbacks of conventional rigid connections, while simultaneously reducing vibration noise and greatly improving driving comfort and driving stability.

The clearance fit between the hexagonal rod and the trailer hitch receiver tube eliminates installation limitations, and the non-circular fit structure effectively restricts rotation to achieve shock absorption, thereby solving the problems of poor turning flexibility and easy interference of conventional rigid trailer hitches; and the integrated design makes the overall structure compact, and the reliable anchor point provided by the bent beam may be adapted to various components such as a rear-mounted towing hook, a ball mount, and a recovery traction board, resulting in a wider range of application scenarios.

The locking pin has a triple-locking structure including locking through a self-weight of the pin handle, anti-movement through the locking cavity, and the double-hole connection to the clip and coded lock. In combination with the dual-position same-model spare design, this not only prevents overall failure caused by loss of the locking pin but also ensures stable connection of all components, thereby eliminating the risk of movement during travel.

The bent beam structure enhances vehicle passive safety, effectively protects vehicle frame and rear compartment structures, while increasing the rigidity of the vehicle body and the torsional stiffness of the whole vehicle; the dual-chain fixing plates achieve dual safety protection; the reinforcing plates on both sides of the trailer hitch receiver tube can prevent component damage caused by vibration friction, thereby providing comprehensive safety protection for towing and hauling.

The detachable hitch step is convenient to remove and flexible to install, and may be fixed on either the first trailer hitch receiver tube or the second trailer hitch receiver tube as needed, thereby facilitating a user's stepping for accessing items; the connection method using the high-strength bolts and lock nuts ensures overall strength; and various types of the shock-absorbing springs are available for selection, thereby meeting personalized requirements for different usage scenarios.

### BRIEF DESCRIPTION OF DRAWINGS

FIG. 1 is a schematic exploded view of a shock-absorbing trailer hitch assembly in the present disclosure.

FIG. 2 is a schematic view of a shock-absorbing trailer hitch in the present disclosure.

FIG. 3 is a schematic view of a shock-absorbing trailer hitch receiver tube in the present disclosure.

FIG. 4 is a schematic view of a locking pin in the present disclosure in two directions.

FIG. 5 is a front functional view of a locking pin in the present disclosure.

FIG. 6 is a schematic view showing cooperation between a hexagonal rod and a buffer sleeve in the present disclosure.

FIG. 7 is a front view showing cooperation between a hexagonal rod and a buffer sleeve in the present disclosure.

FIG. 8 is a schematic view of a shock-absorbing spring mechanism in the present disclosure.

FIG. 9 is a front view of a shock-absorbing trailer hitch in the present disclosure.

FIG. 10 is a schematic view of a shock-absorbing trailer hitch assembly in the present disclosure.

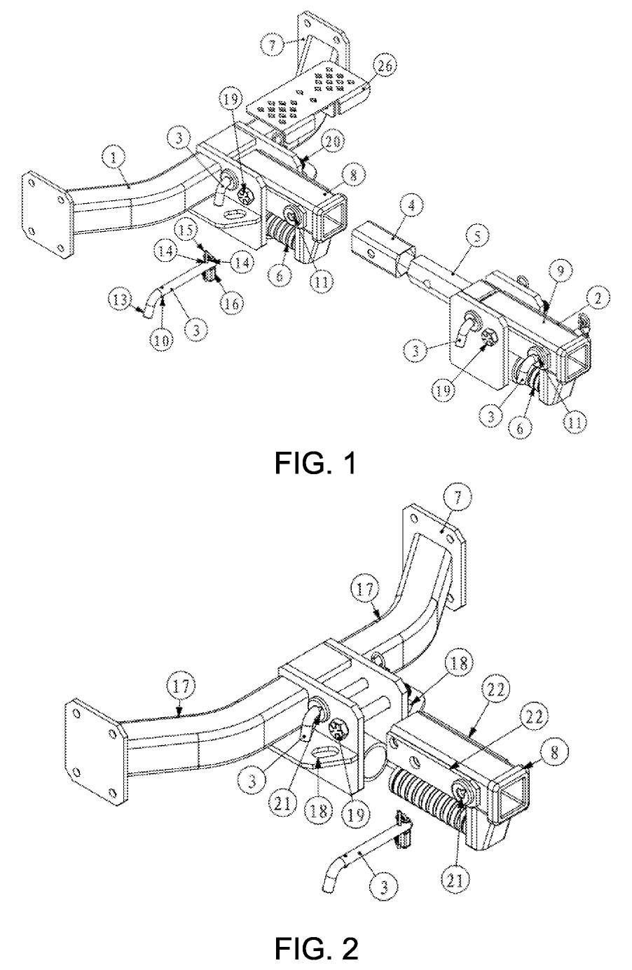

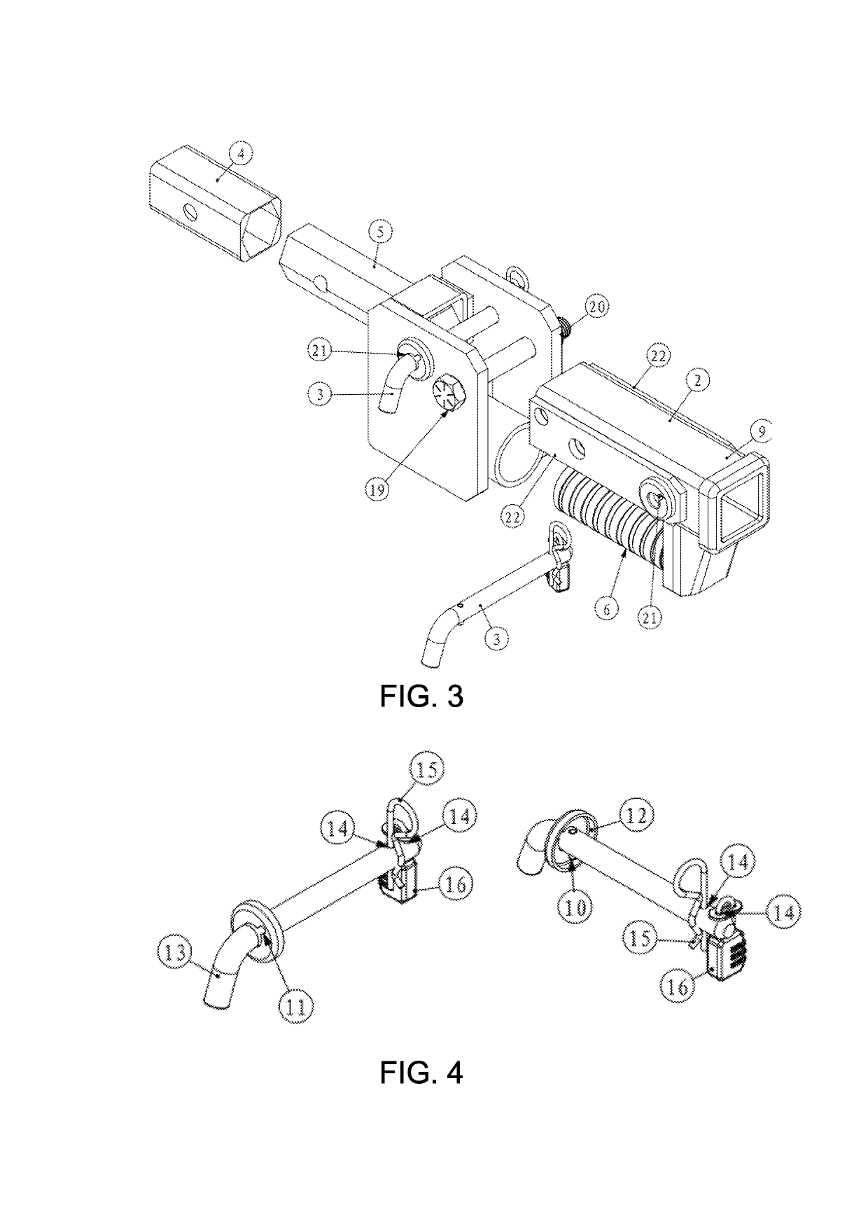

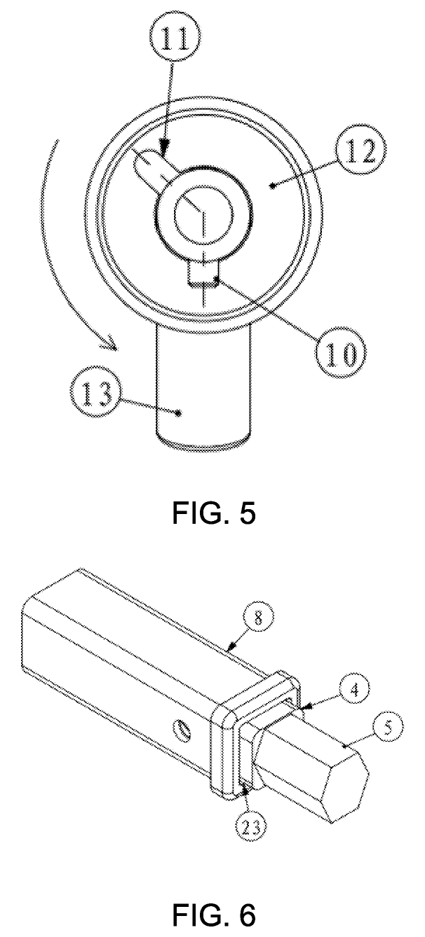

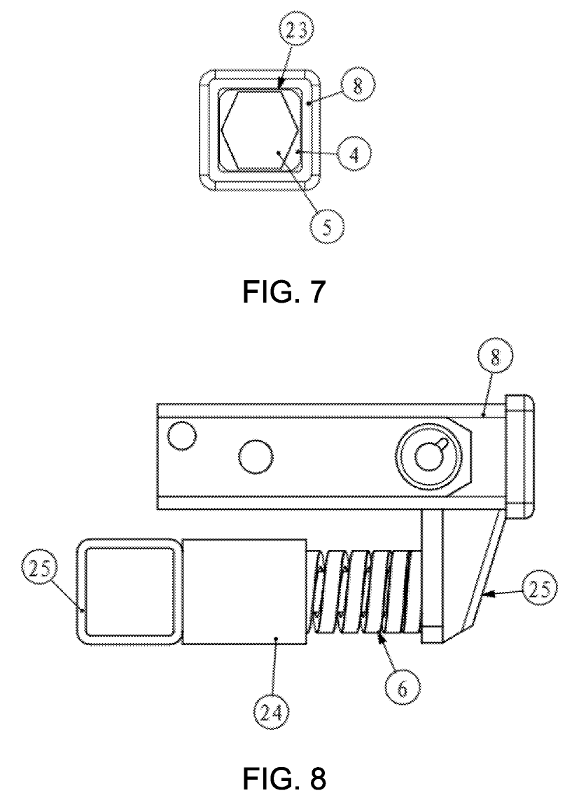

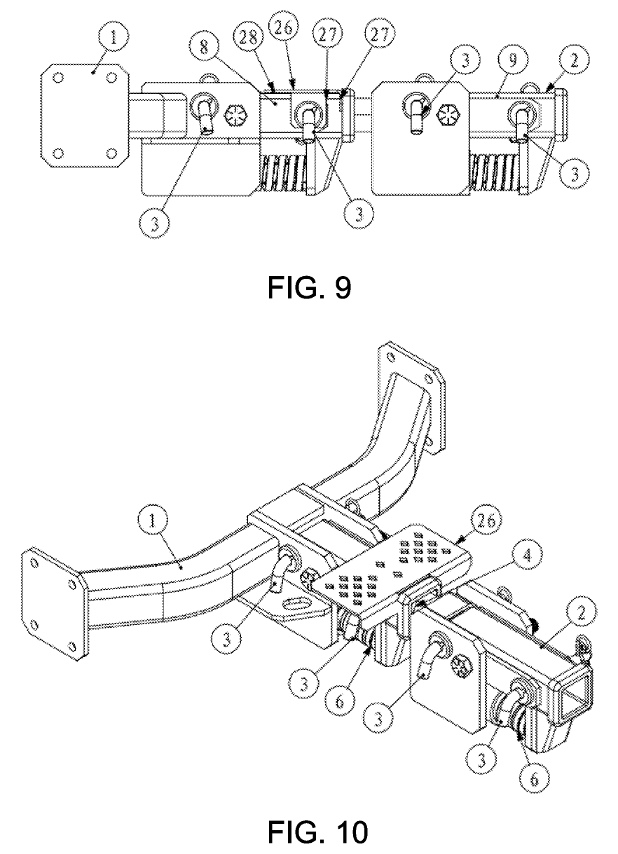

In the figures, the corresponding relationship between component names and reference numerals is as follows: 1-shock-absorbing trailer hitch; 2-shock-absorbing trailer hitch receiver tube; 3-locking pin; 4-buffer sleeve; 5-hexagonal rod; 6-shock-absorbing spring; 7-trailer hitch beam; 8-first trailer hitch receiver tube; 9-second trailer hitch receiver tube; 10-pin stem; 11-latch slot; 12-locking cavity; 13-pin handle; 14-double holes; 15-clip; 16-coded lock; 17-bent beam; 18-dual-chain fixing plate; 19-high-strength bolt; 20-lock nut; 21-dual-position; 22-reinforcing plate; 23-clearance; 24-shock-absorbing spring mechanism; 25-dual-position reinforcement; 26-detachable hitch step; 27-auxiliary side plate; and 28-top surface.

### DESCRIPTION OF EMBODIMENTS

The implementation of the present disclosure is further described below in detail in combination with the drawings and embodiments. The following embodiments are used to illustrate the present disclosure, but are not intended to limit the scope of the present disclosure.

The specific implementation of the present disclosure is described below in detail in combination with the drawings. This implementation is only used to explain the present disclosure and does not define the protection scope of the present disclosure.

### I. Overall assembly process:

The core of the shock-absorbing trailer hitch of the present disclosure is composed of a shock-absorbing trailer hitch 1, a buffer sleeve 4, locking pins 3, and a shock-absorbing trailer hitch receiver tube 2. The components are assembled according to the following steps:

First, a trailer hitch beam 7 of the shock-absorbing trailer hitch 1 is aligned and fastened with a first trailer hitch receiver tube 8 via a high-strength bolt 19 and a lock nut 20 through corresponding connection holes, and a clearance fit is maintained at a connecting port between the first trailer hitch receiver tube 8 and the trailer hitch beam 7. Reinforcing plates 22 on both sides of the first trailer hitch receiver tube 8 enhance the anti-vibration friction capability at the connection.

The non-circular fit between a hexagonal rod 5 of the shock-absorbing trailer hitch receiver tube 2 and the first trailer hitch receiver tube 8 restricts rotation of the hexagonal rod 5 to achieve preliminary shock-absorbing positioning.

A buffer sleeve 4 is sleeved around an outer wall of the hexagonal rod 5 of the shock-absorbing trailer hitch receiver tube 2 to form an interference fit, and an outer wall of the buffer sleeve 4 and an inner wall of the first trailer hitch receiver tube 8 are in clearance 23 fit. The buffer sleeve 4 is made of a wear-resistant buffering material. A clearance 23 is reserved between the buffer sleeve 4 and the first trailer hitch receiver tube 8 to meet buffering requirements, thereby enhancing shock absorption and buffering.

Two same-model locking pins 3 are designed for dual positions 21, and a pin stem 10 of one locking pin 3 is screwed into a locking cavity 12 through a latch slot 11. Preliminary locking is completed by using a self-weight of a pin handle 13; then, a clip 15 and a coded lock 16 are connected through double holes 14 at an end portion of the pin stem 10, respectively. In this way, triple locking is achieved. The other locking pin 3 is stored as a spare part at a designated installation position.

When a detachable hitch step 26 needs to be installed, the detachable hitch step 26 is placed flat on a top surface 28 of the first trailer hitch receiver tube 8, the locking pin 3 is passed through corresponding holes in the hitch step and the first trailer hitch receiver tube 8, and simultaneously four-position fixing is completed by using auxiliary side plates 27 to ensure that the hitch step is installed securely.

### II. Detailed implementation structure of core components:

### (I) Shock-absorbing trailer hitch 1:

The shock-absorbing trailer hitch 1, serving as an overall load-bearing core, employs a shock-absorbing spring 6 to connect the trailer hitch beam 7 and the first trailer hitch receiver tube 8, so as to form an elastic connection structure:

The shock-absorbing spring 6 is selected as a helical spring (which may be replaced with a polyurethane spring, a hydraulic spring, a nitrogen spring, an airbag spring, a leaf spring, a torsion bar spring, or a rubber spring according to actual needs). Both ends of the spring are fixed by welding to a mounting base of the trailer hitch beam 7 and a boss of the first trailer hitch receiver tube 8. The springs have a preset compression amount to ensure effective absorption of shock forces generated by vehicle starting, braking, and bumping.

A bent beam 17 is integrally formed in the middle of the trailer hitch beam 7, and the bent beam 17 is of an arc-shaped structure, which can not only enhance vehicle passive safety performance and protect vehicle frame and rear compartment structures, but also provide a reliable anchor point serving as a mounting base for a rear-mounted towing hook, a ball mount, or a recovery traction board, while simultaneously increasing the rigidity of a vehicle body and the torsional stiffness of a whole vehicle.

Dual-chain fixing plates 18 are symmetrically disposed on both sides of the trailer hitch beam 7, and chain connecting holes are formed in their surfaces and configured to connect safety chains, thereby achieving dual safety protection.

### (II) Shock-absorbing trailer hitch receiver tube 2:

The shock-absorbing trailer hitch receiver tube 2 connects the hexagonal rod 5 and a second trailer hitch receiver tube 9 through a shock-absorbing spring 6, thereby forming a secondary shock-absorbing structure:

The installation method of the shock-absorbing spring 6 is consistent with the installation method of the shock-absorbing spring 6 in the shock-absorbing trailer hitch 1, and elastic buffering capability between the hexagonal rod 5 and the second trailer hitch receiver tube 9 is ensured, thereby overcoming the drawback of a rigid connection in an integral trailer hitch receiver tube.

A clearance fit is used between the hexagonal rod 5 and the first trailer hitch receiver tube 8 to eliminate assembly limitation caused by dimensional deviations during the installation process. Moreover, the non-circular fit structure is used to restrict rotation of the hexagonal rod 5, thereby further enhancing the shock-absorbing effect.

### (III) Buffer sleeve 4:

The buffer sleeve 4 is made of a wear-resistant rubber material (or other equivalent wear-resistant buffering materials) and has an annular structure:

An inner ring of the buffer sleeve 4 closely fits the hexagonal rod 5, and an outer ring thereof fits an inner wall of the first trailer hitch receiver tube 8. This not only fills the clearance 23 between the hexagonal rod 5 and the first trailer hitch receiver tube 8, thereby eliminating vibration noise generated by the clearance during travel.

The buffer sleeve 4 itself has an elastic deformation capability, and can absorb impact energy on a bumpy road or during turning, provide a buffering and protective effect, and reduce rigid collisions between components.

### (IV) Locking pin 3:

The locking pin 3 is overall processed and made of a high-strength alloy steel material, with a structural design as follows:

A latch slot 11 is formed in a surface of the pin stem 10, and cooperates with a detent slot in an inner wall of the locking cavity 12. After the pin stem 10 is screwed into the locking cavity 12, the latch slot 11 can prevent the pin stem 10 from moving.

The pin handle 13 employs an eccentric design, and uses its self-weight to achieve natural locking without requiring additional operation.

Double holes 14 are formed at an end portion of the pin stem 10, and configured to connect the clip 15 and the coded lock 16, respectively. In cooperation with the self-weight locking of the pin handle 13, a triple locking structure is formed, thereby ensuring locking reliability.

Locking pins 3 with a dual-position 21 same-model design are used, and one serves as a spare, preventing overall failure caused by the loss of a single locking pin 3. When a trailer is not connected, the inner locking pin 3 may be inserted into corresponding holes of the first trailer hitch receiver tube 8 and the trailer hitch beam 7, thereby further fixing their positions and enhancing the shock-absorbing effect.

### (V) Shock-absorbing spring mechanism 24 and detachable hitch step 26:

The shock-absorbing spring mechanism 24 employs a dual-position reinforcement 25 design. Reinforcement bases are disposed at mounting positions of the shock-absorbing springs 6 of both the shock-absorbing trailer hitch 1 and the shock-absorbing trailer hitch receiver tube 2, thereby preventing structural defects caused by concentrated spring forces, while simultaneously improving the load-bearing capacity and service life of the shock-absorbing system. The dual-position reinforcement 25 can effectively buffer shock forces generated by vehicle starting, braking, and gear shifting, absorb continuous vibrations, and reduce peak stress.

The detachable hitch step 26 is made of a lightweight high-strength material, with anti-slip patterns disposed on its surface, thereby facilitating a user's stepping for accessing items. The hitch step may be selected to be fixed on either the first trailer hitch receiver tube 8 or the second trailer hitch receiver tube 9 according to usage needs. During removal, only the corresponding locking pin 3 needs to be pulled out, and the operation is convenient without affecting the overall function of the trailer hitch. The four-position fixing structure formed by the auxiliary side plates 27 ensures no looseness of the hitch step after installation.

### III. Operating principle:

Shock absorption and buffering: During vehicle travel, the shock-absorbing spring 6 of the shock-absorbing trailer hitch 1 and the shock-absorbing spring 6 of the shock-absorbing trailer hitch receiver tube 2 form a dual shock-absorbing mechanism; and in cooperation with the elastic buffering effect of the buffer sleeve 4, the shock-absorbing springs 6 can absorb shock forces generated by vehicle starting, braking, and bumping step by step, reduce vibration transmission, eliminate shaking defects brought by rigid connections, and simultaneously lower vibration noise and improve driving comfort.

Shock absorption and anti-rotation: The rotation is restricted through the non-circular fit between the hexagonal rod 5 and the first trailer hitch receiver tube 8; the triple locking structure of the locking pin 3 ensures a stable connection of all components; and the shock-absorbing spring mechanism 24 with a dual-position reinforcement 25 further strengthens structural stability, thereby effectively preventing component movement and rotation during travel.

Safety protection: The bent beam 17 structure enhances vehicle passive safety; safety chains connected to the dual-chain fixing plates 18 achieve dual protection; the triple-locked locking pin 3 ensures connection reliability; and the overall structural design guarantees safety during the towing process.

Multi-function adaptability: The detachable hitch step 26 meets the user's need for stepping to access items; the dual-position 21 main-spare locking pins 3 improve usability convenience; the mounting anchor point provided by the bent beam 17 can be adapted to various components such as a rear-mounted towing hook and a ball mount; and the integrated design makes the trailer hitch more adaptable.

The embodiments of the present disclosure are provided to illustrate and describe, rather than being exhaustive or limiting the present disclosure to the disclosed forms. Many modifications and variations will be apparent to those of ordinary skill in the art. The selection and description of the embodiments are intended to better illustrate the principles and practical applications of the present disclosure, and to enable those of ordinary skill in the art to understand the present disclosure and thereby design various embodiments with various modifications suitable for specific uses.

What is claimed is:

1. A shock-absorbing trailer hitch, comprising a shock-absorbing trailer hitch, a buffer sleeve, locking pins, and a shock-absorbing trailer hitch receiver tube;
a trailer hitch beam of the shock-absorbing trailer hitch is connected to a vehicle on both sides and connected to the buffer sleeve in the middle; and the buffer sleeve is connected to a hexagonal rod of the shock-absorbing trailer hitch receiver tube; and
the locking pin is configured to connect the shock-absorbing trailer hitch, the buffer sleeve, and the shock-absorbing trailer hitch receiver tube in a locked manner.

2. The shock-absorbing trailer hitch according to claim 1, wherein the shock-absorbing trailer hitch is formed by connecting the trailer hitch beam and a first trailer hitch receiver tube through a shock-absorbing spring, the trailer hitch beam and the first trailer hitch receiver tube are fixedly connected by a high-strength bolt and a lock nut, and reinforcing plates are disposed on both sides of the first trailer hitch receiver tube.

3. The shock-absorbing trailer hitch according to claim 1, wherein the shock-absorbing trailer hitch receiver tube is formed by connecting the hexagonal rod and a second trailer hitch receiver tube through a shock-absorbing spring, and the hexagonal rod and the first trailer hitch receiver tube are in a clearance fit and are in a non-circular fit.

4. The shock-absorbing trailer hitch according to claim 1, wherein the buffer sleeve is made of a wear-resistant buffering material, and configured to connect the hexagonal rod and the first trailer hitch receiver tube, and a clearance is retained between the buffer sleeve and the first trailer hitch receiver tube.

5. The shock-absorbing trailer hitch according to claim 1, wherein a pin stem of the locking pin is screwed into a locking cavity through a latch slot, double holes are formed at an end portion of the pin stem, the double holes are connected to a clip and a coded lock, respectively, and the locking pin is further provided with a pin handle.

6. The shock-absorbing trailer hitch according to claim 1, wherein the shock-absorbing trailer hitch is provided with a bent beam structure and dual-chain fixing plates, the bent beam is configured to enhance vehicle passive safety and provide a mounting base, and the dual-chain fixing plates serve a dual safety protection function.

7. The shock-absorbing trailer hitch according to claim 1, wherein locking pins employ a dual-position same-model design, and one locking pin serves as a spare; and when a trailer is not connected, the inner locking pin fixes the first trailer hitch receiver tube and the trailer hitch beam.

8. The shock-absorbing trailer hitch according to claim 1, wherein the shock-absorbing trailer hitch is configured with a detachable hitch step, the detachable hitch step is placed flat on a top surface of the first trailer hitch receiver tube and is fixed at four positions by the locking pin and auxiliary side plates, and the detachable hitch step is fixed for use on either the first trailer hitch receiver tube or the second trailer hitch receiver tube.

9. The shock-absorbing trailer hitch according to claim 1, wherein the shock-absorbing spring is any one of a helical spring, a polyurethane spring, a hydraulic spring, a nitrogen spring, an airbag spring, a leaf spring, a torsion bar spring, and a rubber spring.

10. The shock-absorbing trailer hitch according to claim 1, wherein the shock-absorbing spring mechanisms of the shock-absorbing trailer hitch and the shock-absorbing trailer hitch receiver tube employ a dual-position reinforcement design.
